(19) United States
(12) Patent Application Publication
(10) Pub. No.: US 2013/0323703 A1
(43) Pub. Date: Dec. 5, 2013

(54) Study Aid for Academic Competition

(71) Applicant: Bryce D. Avery, Centennial, CO (US)

(72) Inventor: Bryce D. Avery, Centennial, CO (US)

(73) Assignee: FOOTHILLS EDUCATION, LLC, Centennial, CO (US)

(21) Appl. No.: 13/488,640

(22) Filed: Jun. 5, 2012

(51) Int. Cl. G09B 5/00

(52) U.S. Cl. 434/307 R

(57) ABSTRACT

Disclosed is a study aid with multiple modes that allows users (especially students who participate in academic competitions) to develop expertise within a given subject by playing a game where detailed clues to entries related to the subject are provided in a random order from hardest to easiest. The clues and the ancillary information provided with the clues may also be studied without playing the game. The study aid uses a data interface device such as a computer, smartphone or tablet, including the Apple Computer, Inc. iPhone and iPad.

### BACKGROUND OF THE INVENTION

a. Field of the Invention

The present invention generally pertains to study aids and more particularly to study aids that allow players of quizbowl or other games of academic competition to study common subjects and information within those subjects that appears in those games to learn the information as rapidly and efficiently as possible.

b. Description of the Background

For most of the period since the TV show College Bowl began in the 1950's, and especially since the TV show Jeopardy! was restarted in the 1980's, students of all ages in many countries have participated in academic competitions. Many academic competitions are held according to established local formats and parallel established round-robin leagues in other sports such as football and basketball. One of the most popular formats was begun by College Bowl and involves the use of both “tossup” questions (where the first player to push a buzzer can give the answer) and “bonus” questions (as a reward for the team whose player correctly answers each “tossup”). “Tossup” questions are typically written in “pyramid” form, with the most obscure or difficult clues given first and the most well-known or easiest clues given last so that the team with deeper knowledge is more likely to buzz first and answer the question correctly.

Because “tossups” are so important in academic competition and because every major school subject is asked about in a typical academic competition, top teams typically combine players who each have their own specialty within the major subjects (one literature expert per team, one history expert, one math/science expert, etc.) Thus, students usually want to know how to quickly become an expert in their subject of interest and/or in a subject where their team currently lacks an expert. When a student asks his coach how to become an expert in a subject, however, the coach can currently give only the vaguest of suggestions. Reading a textbook, for example, typically gives only an overview of a subject without discussing in depth the specific events, terms, or people that are often asked about in academic competition. Practicing with an academic competition team helps students learn a few things (especially if a student takes written notes on topics unfamiliar to him), as does playing in actual academic competitions and writing questions for both future academic competitions and for personal study. However, these methods are inefficient and usually require months or years of sustained effort to realize any progress. Thus, academic competitors wishing to know more about even the most famous of topics (George Washington, DNA, the Mona Lisa, etc.) must try to find and read study material not specifically designed for academic competition use while still doing their day-to-day school assignments. An academic competitor who reads a George Washington biography (or article about him in a condensed form, such as those in Wikipedia) must read a tremendous amount of material and ignore the facts within that material that would never appear in academic competition just to find the few bits of information that would actually be useful.

To try and speed the learning process, many study aids of all types have been developed that purport to help students learn important material and learn it faster. These aids typically lack the depth needed to be useful in top-level academic competition because they either try to discuss all major subjects in a single aid, emphasize only one subject but then include only the most superficial and trivial of information within that subject, discuss a subject outside the writer's personal area of expertise (though some science teachers can write useful literature aids, almost no literature teacher can write a useful science aid), use multiple-choice questions (thus narrowing down the number of possible answers far too quickly), or use state-established curriculum standards as a basis for questions that have little or no actual relationship to the material discussed in academic competition. Aids created by students suffer from these limitations to an even greater degree because the student is younger and thus has even less knowledge than an adult does of what is important and what is not (should I include Kate Chopin in this literature aid, Mark Twain, both or neither?)

Students grasping for expertise have improved on these study aids by developing free searchable online databases containing thousands of “pyramid” questions written by academic competitors of the past; search for “George Washington”, for instance, and 25 “pyramid” questions may appear that mention his name, all written by different players over a period of years. However, even this approach is limited by both the number of clues that can appear in a single question because of practical restrictions on question length (typically no more than 10 clues) and by the high number of duplicate clues within those 25 questions. 23 of the 25 may mention that George Washington was America's first President, 22 may mention his wife Martha, 21 may mention Mount Vernon, and 12 may even mention his victory over Cornwallis at Yorktown. None of the 25, however, may mention that he is considered the “Father of the American Mule”, that he was involved in the Jumonville Affair, that he developed the Purple Heart, or that his nephew Bushrod served on the U.S. Supreme Court—all of which is fair game in academic competition. Thus, even studying past “pyramid” questions may teach enough facts for an academic competitor to get a few questions correct but does not teach enough facts to allow for actual expertise in a given subject.

It would therefore be advantageous to have a study aid with multiple modes that would allow academic competitors to develop expertise within a given subject by learning all of the major clues for a given entry through study, through playing a game where those clues appear in an extended “pyramid” order, or through some enjoyable combination of the two that would not require skimming thousands of pages of unhelpful material. It would also be advantageous if the entries used in such a study aid would constitute what educated people would consider the most commonly recognized entries within each subject. It would further be advantageous if such a study aid could be used by students who are not academic competitors to study more quickly and efficiently for national exams in a given subject, such as Advanced Placement® or CLEP® exams. Such a study aid may even be extended for use in non-educational subjects (sports trivia, etc.).

### SUMMARY OF THE INVENTION

The present invention overcomes the disadvantages and limitations of the prior art by providing a study aid with multiple modes that may allow academic competitors to develop expertise within a given subject by learning all of the major clues for a given entry through study, through playing a game where those clues appear in an extended “pyramid” order, or through some enjoyable combination of the two that would not require skimming thousands of pages of unhelpful material. The entries used in such a study aid may constitute what educated people would consider the most commonly recognized entries within each subject. Such a study aid may also be used by students who are not academic competitors to study more quickly and efficiently for national exams in a given subject, such as Advanced Placement® or CLEP® exams. Such a study aid may even be extended for use in non-educational subjects (sports trivia, etc.).

The present invention may thus comprise a study aid, embodied on a computer readable medium, that is used with a data interface device to provide rapid and efficient study of a subject consisting of a set of entries each containing a set of clues ordered by clue number, comprising: a “game” mode in which the study aid presents to a user clues in order of descending clue number within the set of clues within the set of entries and allows a user to play a game that develops and tests knowledge of the set of entries within the subject; a “study by entry” mode in which the study aid allows a user to choose any entry within the set of entries within the subject, presents only the clues for that entry, and thus allows a user to study those clues; and, a “study by clue number” mode in which the study aid allows a user to choose any available clue number within the set of entries within the subject, modifies the “game” mode to present only the clues associated by the study aid with that clue number, and thus allows a user to play a game that develops and tests knowledge of the entries within the subject.

The study aid may generate the order of descending clue number within the “game” mode by randomly choosing an available clue number within the entries within the subject, presenting the clue associated with the clue number to a user, and then, if a user provides an incorrect answer to the clue, subtracting a random integer from the clue number and using the result of the subtracting as the next clue number to present to the user. The subtracting of a random integer from a clue number is modified to always subtract exactly one from a clue number whenever the clue number is less than a specified value.

The set of clues may contain at least 20 clues. The subject may commonly appear in academic competition, when preparing for an exam (including the Advanced Placement® or CLEP® exams), or in sports trivia contests. The set of entries and set of clues may be written, developed and presented to maximize success in any of these fields.

The study aid may use a data interface device such as a computer, smartphone or tablet, including an APPLE iPHONE® or iPAD®-.

The present invention may also comprise a method of using a study aid, as embodied on a computer readable medium and used with a data interface device to provide rapid and efficient study of a subject, comprising: developing a set of entries pertaining to the subject; writing a set of clues for each entry within the subject; ordering the clues by clue number; loading the entries, the clues and the clue numbers into the study aid; creating said study aid with a “game” mode, a “study by entry” mode and a “study by clue number” mode; using the “game” mode of the study aid, when selected by a user, to present to the user a game during which the study aid presents clues in order of descending clue number within the set of clues within the set of entries and allows the user to develop and test user knowledge of the set of entries within the subject; using the “study by entry” mode of the study aid, when selected by a user, to allow a user to choose any entry within the set of entries within the subject and study only those clues pertaining to that entry; and, using the “study by clue number” mode of the study aid, when selected by a user, to allow the user to choose any available clue number within the set of entries within the subject and play a modification of the “game” mode that presents only the clues associated by the study aid with the clue number and allows a user to play a game that develops and tests knowledge of the set of entries within the subject. The study aid may generate the order of descending clue number within the “game” mode by randomly choosing an available clue number within the entries within the subject, presenting the clue associated with the clue number to a user, and then, if the user provides an incorrect answer to the clue, subtracting a random integer from the clue number and using the result of the subtracting as the next clue number to present to the user. The subtracting of a random integer from the clue number is modified to always subtract exactly one from the number of a clue whenever the number of a clue is less than a specified value. The study aid may use a data interface device such as a computer, smartphone or tablet, including an APPLE iPHONE® or iPAD®

The advantages of the present invention include: allowing users to study useful information quickly and efficiently while avoiding non-useful information, increasing a user's memory of that information and enjoyment of learning through the playing of a game, and the information provided for a given entry that is both more and deeper than the information listed in even the best “pyramidal” questions in academic competition.

### BRIEF DESCRIPTION OF THE DRAWINGS

In the drawings,

FIG. 1 is a representation of the various modes of the present invention.

FIG. 2 is a flowchart of the “game” mode of the present invention.

### DETAILED DESCRIPTION OF THE INVENTION

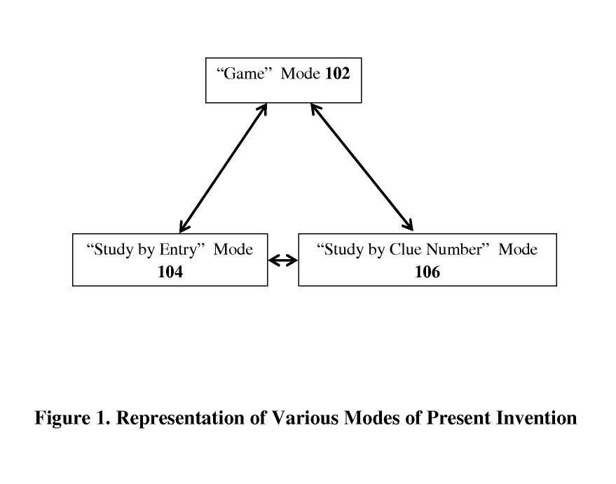

FIG. 1 is a representation of the various modes of the present invention that may all be available to a user when the present invention is activated on a data interface device such as a computer, smartphone or tablet. The “game” mode 102 may allow a user to play a game that gives successive clues to one entry within a list of entries that all share a common characteristic (U.S. Presidents, famous paintings, etc.). Each entry within a given subject may typically have the same number of clues. Each entry may have a set of clues for it that may be “pyramidally” ordered from hardest to easiest. In the most common embodiments, clues for a given entry may be numbered beginning with the highest number in the game (the hardest clue) and ending with 1 (the easiest clue). One inventive step of the present invention is the extension of the “pyramid” concept from the typical 10 clues or less (allowing minimal coverage of some important information about each entry) to much larger numbers of clues (usually 20 or more, allowing full coverage of all important information about each entry), something that has not been done in the previous 60 years of academic competition.

Clues for a single entry may be given to a user one at a time in random order from hardest to easiest (thus utilizing the “pyramid” style) until the user recognizes and inputs the correct entry. This random order, including the first clue not always being the hardest clue available in a set, is one inventive step of the present invention and may add variety and usefulness to the game, preventing the user from quickly learning a single hard clue and then never seeing (or learning) any clues after it. Over time, a user may thus expect to learn all of the clues for a given entry and then all of the clues for all of the entries in the entire subject.

In typical embodiments, the random order may be used for most clues in a game and then be modified for the easiest few clues by subtracting only 1 from the clue number each time in order to extend the game's usefulness. For example, the first time an entry appears that has 40 clues, its clue order may be 40, 33, 29, 25, 18, 13, 7, 4, 3, 2, 1, while the next time the entry appears, its clue order may be 38, 34, 27, 23, 19, 12, 8, 4, 3, 2, 1. In this example, the clues may appear in random order from hardest to easiest for all numbers greater than 4, but once clue number 4 is displayed, only 1 is subtracted from the clue number for each successive clue until either the clue number reaches zero or a correct answer is input. This is one inventive step of the present invention, allowing a user to learn those clues first and fastest (because they are seen every single time) that are considered “basic information” for all educated people to know about a given entry whether they play in academic competitions or not.

The present invention's “study by entry” mode 104 may allow a user to select an entry within a given subject and read all of the clues provided in the “game” mode 102 for that entry as arranged from hardest to easiest. In typical embodiments of the “study by entry” mode, clues for an entry may be studied without playing the “game” mode 102. Allowing a user to study without playing the “game” mode improves the user's knowledge and may allow the “game” to be completed more quickly when played next.

Clues may also have certain words or phrases highlighted in the “study by entry” mode 104 (but not highlighted when the clue appears in the “game” mode 102) that, when selected, link to ancillary information for the given entry that allows deeper study, such as a relevant website. A clue mentioning the U.S. Supreme Court, for example, may have the phrase “Supreme Court” highlighted in the “study by entry” mode 104 (but not highlighted when the clue appears in the “game” mode 102); when the phrase is selected, the website http://www.supremecourt.gov may appear, allowing the interested user to read everything on the Supreme Court website.

The present invention's “study by clue number” 106 mode, an inventive step of the present invention, may allow a user to select a clue number and play the “game” mode 102 by seeing only the clue with the selected number for each entry in the subject, as shown in the “study by entry” mode 104. A user may typically begin in this mode by selecting the number “1” to see and learn all of the easiest clues in the subject; as the user gains knowledge and confidence, he may progress to “2”, “3”, etc. until he reaches the highest clue number available in the subject, learns all the clues with that number, and thus presumably knows every clue in the entire subject.

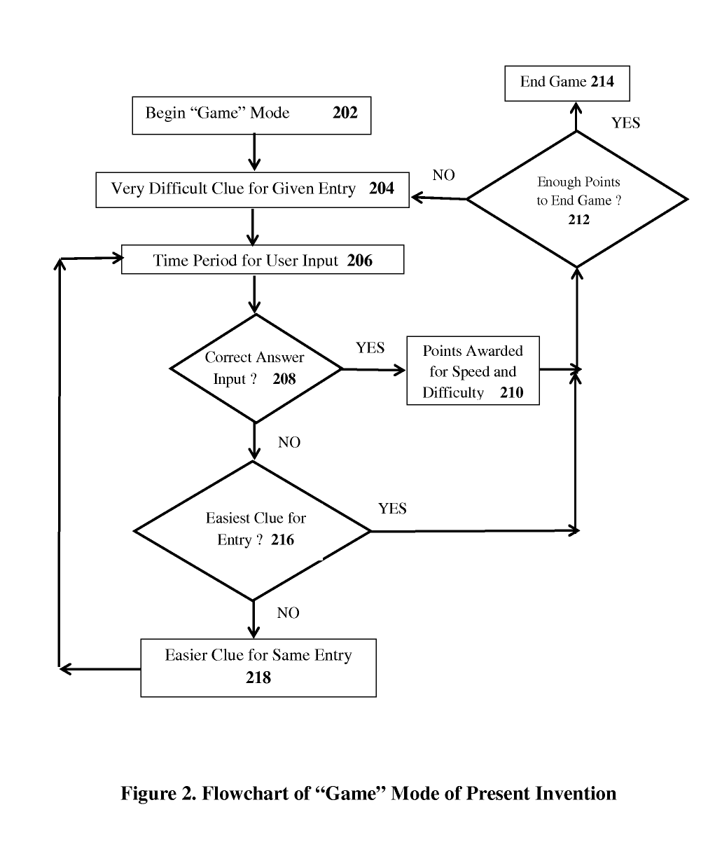

FIG. 2 illustrates a flowchart of one embodiment of the “game” mode (102 in FIG. 1). When the “game” mode begins 202, the user may see a clue that may be randomly chosen by the game within the subset of most difficult clues 204 for a given entry. The user may be given a period of time 206 to input his answer to a data interface device, typically using a keyboard of some type. The “game” may then compare the user's answer to a list of acceptable correct answers 208 for the given entry; if the user's answer is considered correct, he may receive a number of points 210 that is directly proportional to both the difficulty of the clue and the speed with which the answer was input. The game may then continue with one of the most difficult clues for another randomly chosen entry within the given subject until a certain number of points is accrued 212 that results in the end of the game 214.

An incorrect user input 208 may result in displaying another clue for the same entry 218 that is easier than the previous clue, provided that the easiest clue for a given entry 216 has not yet been given to the user. In typical embodiments, an easier clue may be chosen from the set of clues for each entry by randomly subtracting an integer (typically between 1 and 10) from the number of the previous clue for the entry; this is done because showing all the clues in consecutive order from hardest to easiest without any randomization may allow a user to learn only a few clues for a given entry and thus attain mastery of game play without actual mastery of all of the clues for a given entry or mastery of all of the entries within a given subject. This “pyramidal” process of showing successively easier clues for the same entry may continue until either the user inputs a correct answer 208 and receives points 210 or inputs an incorrect answer 208 after seeing the easiest clue for the entry 216. In this latter case, the user receives no points and begins the process again with a very difficult clue for another entry within the given subject until a certain number of points is accrued 212 that results in the end of the game 214.

The present invention therefore provides a study aid with multiple modes that may allow users, especially students and academic competitors, to develop expertise within a given subject by learning all of the important clues for a set of entries within that subject. Such expertise may be developed by playing a game where those clues may appear in “pyramid” order, by specific study of those clues and any ancillary information, or by some combination of the two that does not require skimming thousands of pages of unhelpful material. The entries in such a study aid may constitute what most people would consider to be the most commonly recognized entries within each subject. Such a study aid may be used in studying multiple subjects and in studying more quickly and efficiently for national exams such as Advanced Placement® or CLEP® exams.

Besides its use with a computer, the usefulness of the present invention may be extended by use with other data interface devices, including a smartphone (such as APPLE's iPHONE®) or tablet (such as APPLE's iPAD®). Further embodiments of the present invention may extend the study aid to preparation for specific exams, other fields outside of education (trivia about sports teams, etc.), and to languages other than English.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A study aid, embodied on a computer readable medium, that may be used with a data interface device to provide rapid and efficient study of a subject consisting of a set of entries each containing a set of at least 20 clues ordered by clue number, comprising:
a “game” mode in which said study aid presents to a user clues in order of descending clue number within said set of clues within said set of entries and allows said user to play a game that develops and tests knowledge of said set of entries within said subject;
a “study by entry” mode in which said study aid allows a user to choose any entry within said set of entries within said subject, presents only the clues for said entry, and thus allows said user to study said clues; and,
a “study by clue number” mode in which said study aid allows a user to choose any available clue number within said set of entries within said subject, modifies said “game” mode to present only the clues associated by said study aid with said clue number, and thus allows said user to play a game that develops and tests knowledge of said entries within said subject.

2-4. (canceled)

5. The study aid of claim 1, wherein said study aid generates said order of descending clue number within said “game” mode by randomly choosing an available clue number within said entries within said subject, presenting said clue associated with said clue number to a user, and then, if said user provides an incorrect answer to said clue, subtracting a random integer from said clue number and using the result of said subtracting as the next clue number to present to said user.

6. The study aid of claim 5, wherein said subtracting of said random integer from said clue number is modified to always subtract exactly one from said clue number whenever said clue number is less than a specified value.

7. (canceled)

8. The study aid of claim 1, wherein said data interface device is a computer, smartphone or tablet.

9. The study aid of claim 8, wherein said smartphone is an APPLE iPHONE®.

10. The study aid computer program of claim 8, wherein said tablet is an APPLE iPAD®.

11. A method of using a study aid, as embodied on a computer readable medium and used with a data interface device, to provide rapid and efficient study of a subject comprising:
developing a set of entries pertaining to said subject;
writing a set of at least 20 clues for each entry within said subject;
ordering said set of clues by clue number;
loading said entries, said set of clues and said clue numbers into said study aid;
creating said study aid with a “game” mode, a “study by entry” mode and a “study by clue number” mode;
using said “game” mode of said study aid, when selected by a user, to present to said user a game during which said study aid presents clues in order of descending clue number within said set of clues within said set of entries and allows said user to develop and test user knowledge of said set of entries within said subject;
using said “study by entry” mode of said study aid, when selected by a user, to allow said user to choose any entry within said set of entries within said subject and study only those clues pertaining to said entry; and,
using said “study by clue number” mode of said study aid, when selected by a user, to allow said user to choose any available clue number within said set of entries within said subject and play a modification of said “game” mode that presents only the clues associated by said study aid with said clue number and allows said user to play a game that develops and tests knowledge of said set of entries within said subject.

12-14. (canceled)

15. The method of claim 11, wherein said study aid generates said order of descending clue number within said “game” mode by randomly choosing an available clue number within said entries within said subject, presenting said clue associated with said clue number to a user, and then, if said user provides an incorrect answer to said clue, subtracting a random integer from said clue number and using the result of said subtracting as the next clue number to present to said user.

16. The method of claim 15, wherein said subtracting of said random integer from said clue number is modified to always subtract exactly one from said clue number whenever said clue number is less than a specified value.

17. (canceled)

18. The method of claim 11, wherein said data interface device is a computer, smartphone or tablet.

19. The method of claim 18, wherein said smartphone is an APPLE iPHONE®.

20. The method of claim 18, wherein said tablet is an APPLE iPAD®.

21. The study aid of claim 1, wherein said subject commonly appears in academic competition and both said set of entries and said set of clues are written, developed and presented to maximize success in academic competition.

22. The study aid of claim 1, wherein said subject is commonly studied when preparing for an exam and both said set of entries and said set of clues are written, developed and presented to maximize success on said exam.

23. The study aid of claim 22, wherein said exam is an Advanced Placement® or CLEP® exam.

24. The study aid of claim 1, wherein said subject is sports trivia and both said set of entries and said set of clues are written, developed and presented to maximize success in sports trivia contests.

25. The method of claim 11, wherein said subject commonly appears in academic competition and wherein both said set of entries and said set of clues are all presented by said study aid, written and developed to maximize success in academic competition.

26. The method of claim 11, wherein said subject commonly appears on an exam and wherein both said set of entries and said set of clues are all presented by said study aid, written and developed to maximize success on said exam.

27. The method of claim 26, wherein said exam is an Advanced Placement® or CLEP® exam.

28. The method of claim 11, wherein said subject is sports trivia and wherein both said set of entries and said set of clues are all presented by said study aid, written and developed to maximize success in sports trivia contests.
